(19) United States
(12) Patent Application Publication
(10) Pub. No.: US 2023/0286017 A1
(43) Pub. Date: Sep. 14, 2023

(54) DEVICE AND METHOD FOR COATING A SURFACE

(71) Applicant: HOMAG GmbH, Schopfloch (DE)

(72) Inventor: Thomas BETTERMANN, Bielefeld (DE)

(21) Appl. No.: 18/029,006

(22) PCT Filed: Sep. 29, 2021
(86) PCT No.: PCT/EP2021/076778

§ 371 Date: Mar. 28, 2023

(30) Foreign Application Priority Data
Oct. 1, 2020 (DE) 10 2020 125 687.6

(51) Int. Cl. B05D 3/12; B05C 1/04; B05C 9/12; B05D 5/06; B05D 1/02

(52) U.S. Cl. CPC B05D 3/12; B05C 1/04; B05C 9/12; B05D 5/063; B05D 1/02; B05D 2501/00

(57) ABSTRACT

The invention relates to a device (100) and method for coating a surface, in particular a surface of a plate-shaped workpiece (W). The device and method can be used, for example, in the field of the furniture and components industry.

### TECHNICAL FIELD

The invention relates to a device and method for coating a surface, in particular a surface of a plate-shaped workpiece. The device and method can be used, for example, in the field of the furniture and components industry.

### PRIOR ART

Various approaches for coating a surface of a plate-shaped workpiece are already being pursued. It is also known in this regard to adjust the gloss value of a surface to give the workpiece a specific external appearance in addition to the pattern or colour of the surface. Such workpieces can appear more glossy or more matt as required.

Described in DE 10 2011 018 348 A1 is a device for determining the folding behaviour and folding kinetics of the surface of coatings with radiation-hardenable paints and varnishes initiated by short-wave monochromatic excimer UV radiation. Such a device is provided for determining and assessing the microfolding behaviour and folding kinetics of radiation-hardenable paints and varnishes and the binder components thereof, and is used to test the photochemical microfoldability of paint and varnish formulations in the development phase, to simulate the technological processes realistically and to obtain all the necessary information quickly and easily.

Various methods for adjusting a specific gloss value over a wide area are already known. For example, a UV varnish can be applied to a surface of a workpiece by means of rollers.

Also known is a method with which a local adjustment of a gloss value can be achieved. EP 1 990 204 A1 in particular relates to a process for coating a surface of an object. In the course of the process, a desired gloss value of the coated surface is selected from a gloss scale before a coating is produced, and the coating material is ejected from the outlets of a coating head onto the surface to be coated in such a manner that the selected gloss value of the coated surface is obtained. In order to achieve the selected gloss value, a parameter selected from droplet size, droplet spacing, drying time, nature and properties of the ejected coating material is varied.

Thus, even though there are already various possibilities for adjusting a gloss value, the known methods are relatively complex and thus prone to error. These aspects often prevent them from being used, especially when producing high quantities of items.

### DESCRIPTION OF THE INVENTION

An object forming the basis for the invention is therefore to provide a device as well as a method that enables a gloss value to be adjusted in industrial use in a cost-efficient manner.

This is achieved by the device described in claim 1. Preferred embodiments of the device are specified in the dependent claims and/or described below. The invention furthermore provides a method, the preferred variants of which are described in the dependent claims and/or below. The device according to the invention may be configured to carry out said method. Said device or one of the preferred embodiments may accordingly be used within the scope of the method.

The device for coating a surface of a workpiece, in particular a plate-shaped workpiece, comprises: a first application device for applying a first coating, in particular a varnish, and a second application device for applying a second coating, in particular a varnish. Also provided is a device for introducing texturing into the first coating applied by the first application device.

The method according to the invention can be used to set a specific gloss value, preferably measured as a reflectometer value according to ISO 2813.

The device according to the invention as well as the method according to the invention are based on the realisation that cost-efficient manufacturing on an industrial scale is made possible with the corresponding approach.

It is preferred that the device for introducing texturing is a machining device. This approach can be used to precisely and targetedly influence the appearance of the workpiece depending on the result of the machining and thus on the setting of a specific degree of roughness, for example to make a workpiece appear more matt or shiny.

The device for introducing texturing may in particular be a sanding device. A sanding device can be used for texturing a surface to a desired extent, in particular to produce a desired degree of roughness.

The sanding device preferably comprises an abrasive, the abrasive being exchangeable and/or the abrasive having areas with different grain sizes. Thus, a different texturing can be formed on the workpiece as required.

According to one embodiment, the sanding device comprises a circumferential sanding belt, with which machining can be performed. It is preferred that the sanding belt is moved in the direction of relative movement between the workpiece and the sanding device.

According to a further embodiment, a suction device may furthermore be provided to remove chip residues, such as sanding dust, and to thus prepare for a subsequent processing step.

According to a further embodiment, the sanding belt is exchangeable and/or the sanding belt has areas with different grain sizes. Thus, a different texturing can be formed on the workpiece as required. This can take place in particular by exchanging the sanding belt and/or by positioning the sanding belt relative to the workpiece, for example by moving the sanding belt or by setting a stop for guiding the workpiece.

It is preferred that the first application device and/or the second application device is/are a spray application device or an inkjet device so that a contactless application of a coating material is enabled.

The device for introducing texturing may comprise a pressure device that is configured to apply a variable contact pressure. The design of the texturing can be varied and/or adjusted in this manner.

According to a further embodiment, the device may comprise a printing device, in particular an inkjet printing device, which is arranged such that a decorative element applied using the printing device can be provided with the first coating by means of the first application device. The functionality of the device is thus extended.

It is preferred that a conveying device for moving the workpiece in a conveying direction is provided. A high throughput can thus be achieved. It is particularly preferred that the conveying device is configured as a belt conveyor, a conveyor belt or a conveyor chain. Conveying devices of this type have proven their worth in the woodworking industry.

According to a further embodiment, a control device is provided that is configured to control the device for introducing texturing in such a manner that the texturing is changed, in particular on the basis of a gloss scale, preferably measured as a reflectometer value according to ISO 2813. The variability of the device can be increased further in this manner.

It can additionally or alternatively be provided that the control device is configured to make adjustments by changing a contact pressure, a relative speed between a device for introducing texturing and the workpiece, a direction of relative movement between a device for introducing texturing and the workpiece, or a change of device for introducing texturing. The type and/or characteristics of the texturing can thus be adjusted and/or changed.

It is preferred that a narrow side of a workpiece is coated with the device and method.

The device may further comprise a device for applying a, preferably band-shaped, coating material, in particular a strip-shaped coating material, such as an edge band material. The device for applying a coating material may be arranged such that the first application device for applying a second coating is arranged on the coating material, in particular a narrow surface coating material.

The device may furthermore comprise a device for detecting a gloss value of a further surface of the workpiece, in particular the broad surface of the workpiece. The device may be configured to control the device for introducing texturing into the first coating applied by the first application device such that an obtained gloss value matches the gloss value of the further surface of the workpiece.

If texturing is introduced into a first coating by means of a sanding device, different degrees of gloss or matt can also be produced if the sanding unit is equipped with abrasives of different grain sizes.

The invention furthermore provides a method. The method for coating a surface of a workpiece comprises the steps of: applying a first coating, in particular a varnish, to the workpiece, introducing texturing into the first coating, and applying a second coating, in particular a varnish, to the machined first coating.

It is preferred that the steps of the method are carried out in the cited order.

According to one embodiment, the first coating is hardened, in particular using a UV source, before the texturing is introduced. By using a UV source, it is possible to further speed up the hardening of the coating.

It is preferred that the texturing is introduced by machining, in particular by means of sanding. A surface can thus be textured to a desired extent and in a targeted manner, in particular in order to produce a desired degree of roughness, in particular by means of the design and depth of the texturing.

It is furthermore preferred that the texturing is adjusted by changing a contact pressure, a relative speed between a device for introducing texturing and the workpiece, a direction of relative movement between a device for introducing texturing and the workpiece, or a change of the device for introducing texturing.

The workpieces coated within the context of the method are preferably plate-shaped workpieces. The workpieces may consist, at least in sections, of wood, wood materials, composite materials or the like. Purely by way of example, such a workpiece is an element of a piece of furniture, a floor or ceiling panel or the like.

Within the context of the method, it may be provided that a, preferably band-shaped, coating material is applied to the workpiece, which coating material is provided with the first coating. It is in particular a strip-shaped coating material, such as an edge band material.

The coating material may be made of a plastic material or a veneer.

### BRIEF DESCRIPTION OF THE DRAWINGS

Further features and advantages are apparent from the following description of embodiments with reference to the accompanying figures.

FIG. 1 shows a perspective view of a device according to a first embodiment.

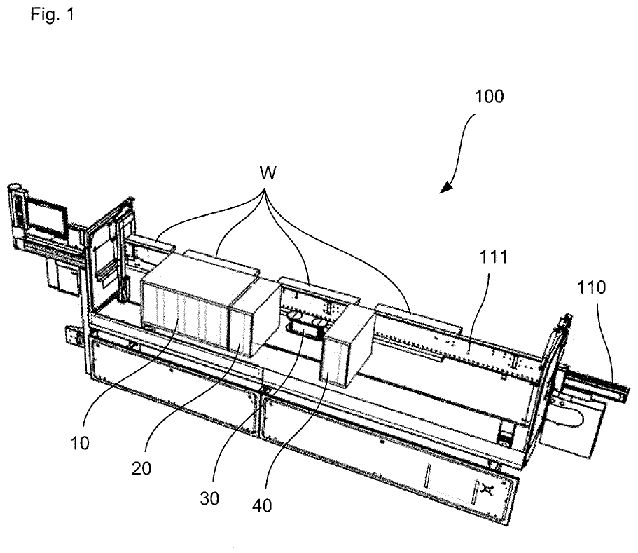

FIG. 2 shows another view of the device according to the first embodiment.

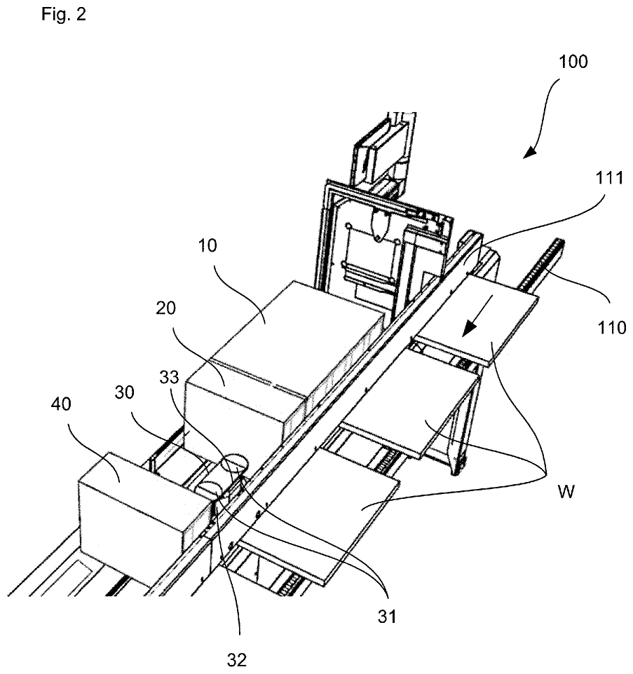

FIG. 3 shows a schematic structure of a device according to a second embodiment.

### DESCRIPTION OF EMBODIMENTS

Identical reference numbers that are used in different figures designate identical, corresponding or functionally similar elements.

According to a first embodiment, a coating device 100 is provided which is configured as a throughfeed machine and which comprises a conveying device 110 for moving workpieces W. The conveying device 110 extends in a conveying direction and is configured to move plate-shaped workpieces W in the conveying direction. In the embodiment example, the conveying device 110 is configured as a belt conveyor; however, a conveyor belt or a conveyor chain may also be used.

The coating device 100 furthermore includes a top pressure member 111 which comprises a circumferential holding device (not shown) also extending in the conveying direction and holds the workpieces in a fixed state during conveying.

The plate-shaped workpieces W may, in particular, be workpieces made of wood, wood materials, composite materials or the like, such as are used in the field of the furniture processing industry. Purely by way of example, such a workpiece is an element of a piece of furniture, a floor or ceiling panel or the like.

The coating device 100 comprises a printing device 10 for providing a narrow side of the plate-shaped workpiece W with a specific decorative element, in particular a specific colour or a specific pattern. For this purpose, the printing device 10 comprises an inkjet print head that is configured to print the narrow side of the workpiece W. Such an inkjet print head can output the colours black, magenta, yellow and cyan and combine them accordingly. A multicoloured pattern can be created on the workpiece by combining the different colours.

Arranged downstream of the printing device 10 in the conveying direction is a first application device 20, which is configured to apply a first varnish (first coating) to the narrow side of the workpiece W. According to the embodiment, the first application device 10 is also equipped with an inkjet device for spraying the varnish onto the narrow side of the workpiece. A contactless application of the varnish can thus be implemented. According to a modification of the first application device 20, application by means of a roller arrangement is also possible.

Provided downstream of the first application device 20 in the conveying direction is a sanding device 30 that comprises two deflection rollers 31 and a sanding belt 32. The sanding device 30 is dimensioned such that narrow sides of workpieces having different thicknesses can be subtractively machined. By machining the first varnish using the sanding device 30, a specific texture/texturing is introduced into the first varnish.

The sanding device 30 comprises a pressure device 33 that presses the sanding belt 32 running around the deflection rollers 31 against a narrow side of a workpiece W. The engagement of the sanding belt 32 with the narrow side of the workpiece varies depending on the contact force applied by the pressure device 33, and thus the design and depth of the texturing of the surface of the workpiece W to be machined with the sanding device 30 can be changed accordingly. Furthermore, the speed and direction of travel of the sanding belt 32 can be varied to influence a machining result.

The sanding belt 32 is replaceable, and thus sanding belts with different grain sizes or a different scattering of the abrasive grains on the sanding belt can be used. The machined surface may have a different texturing depending on the grain size of a particular sanding belt.

The sanding device 30 may furthermore be equipped with a sanding belt having areas with different grain sizes or areas with a different scattering of the abrasive grains provided on the sanding belt, and thus a corresponding texturing can be selected by positioning the sanding device, in particular positioning in a vertical direction, and by engaging a specific area of such a sanding belt with the narrow side of the workpiece W.

Downstream of the sanding device 30 in the conveying direction the coating device 100 comprises a second application device 40 that is configured in a similar manner to the first application device 20. The second application device 40 in particular comprises a device for the contactless application of a second varnish (second coating) to the narrow side of the workpiece W, such as an inkjet device. According to a modification of the first application device 20, application by means of a roller arrangement is also possible.

The coating device 100 comprises a control device with which the described components of the coating device 100, in particular the conveying device 110, the printing device 10, the first application device 20, the sanding device 30 and the second application device 40, can be controlled. In this manner, a workpiece can be processed such that it has a specific gloss value. For this purpose, in particular the respective layer thickness of the first varnish and the second varnish as well as the type of texturing introduced into the first varnish are controlled.

A method can thus be performed with the coating device 100, in which a decorative element, in particular a colour and/or pattern, is first of all applied to a narrow side of a workpiece W by means of the printing device 10. Once the decorative element has dried or the drying process has started, a first varnish is applied to the narrow side of the workpiece W by means of the first application device 20.

Once the applied first varnish has at least partly hardened, the surface of the workpiece provided with a first layer of varnish engages with the sanding device 30. The sanding device 30 sands the surface of the workpiece such that a corresponding texturing is created in the surface of the workpiece provided with varnish. The type of texturing can be adjusted according to a previously described method. The textured surface of the first varnish is subsequently provided with a second varnish by means of the second application device 40 and is thus sealed.

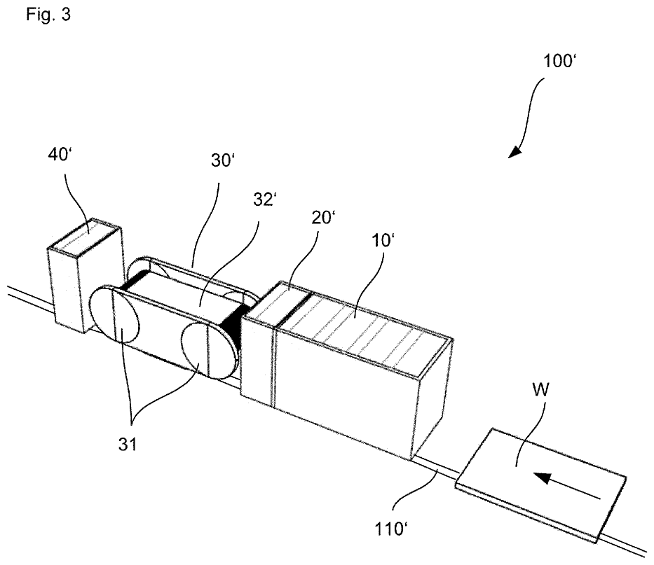

According to FIG. 3, a second embodiment of a coating device 100′ is described by means of a schematic view. Similar to the coating device 100 according to the first embodiment, the coating device 100′ comprises a printing device 10′, a first application device 20′, a sanding device 30′ and a second application device 40′. However, the cited components are configured for machining and/or coating a wide surface of a workpiece W.

As regards the mode of function of the components of the coating device 100′, in particular the first application device 20′, the sanding device 30′ and the second application device 40′, reference is made to the explanation of the first embodiment.

Even though the described embodiments relate to throughfeed machines in which a workpiece is moved by means of a conveying device, the described technology can also be used in machines in which a workpiece is held, at least temporarily, during a coating process. For this purpose, such a coating device may comprise a movable unit comprising a first application device, a second application device and a machining device, in particular a sanding device, the machining device being arranged such that it machines a first coating applied by the first application device. The first application device, a second application device and a machining device may, for example, be accommodated in a unit that is guided along a narrow side of a plate-shaped workpiece during the coating process.

As regards the mode of function of the first application device, the sanding device and the second application device, reference is additionally made to the explanation of the first embodiment.

It is apparent to the person skilled in the art that individual features described in different embodiments can also be implemented in a single embodiment, provided that they are not structurally incompatible. Similarly, various features described in the context of a single embodiment may also be provided in several embodiments either individually or in any suitable sub-combination.

1. A device for coating a surface of a workpiece, comprising:
a first application device for applying a first coating and
a second application device for applying a second coating; and
a device for introducing texturing into the first coating applied by the first application device.

2. The device according to claim 1, wherein the device for introducing texturing is a machining device.

3. The device according to claim 1, wherein the device for introducing texturing is a sanding device.

4. The device according to claim 3, wherein the sanding device comprises a circumferential sanding belt.

5. The device according to claim 4, wherein the sanding belt is exchangeable or the sanding belt has areas with different grain sizes.

6. The device according to claim 1, wherein the first application device and/or the second application device is a spray application device or an inkjet device.

7. The device according to claim 1, wherein the device for introducing texturing comprises a pressure device that is configured to apply a variable contact pressure.

8. The device according to claim 1, further comprising an inkjet printing device, which is arranged such that a decorative element applied using the printing device can be provided with the first coating by means of the first application device.

9. The device according to claim 1, further comprising a conveying device for moving the workpiece in a conveying direction.

10. The device according to claim 1, further comprising a control device that is configured to control the device for introducing texturing in such a manner that the texturing is changed, wherein the control device is configured to make adjustments by changing a contact pressure, a relative speed between the device for introducing texturing and the workpiece, a direction of relative movement between the device for introducing texturing and the workpiece, or a change of device for introducing texturing.

11. A method for coating a surface of a workpiece, comprising the steps of:
applying a first coating to the workpiece;
introducing texturing into the first coating; and
applying a second coating to the textured first coating.

12. The method according to claim 11, wherein the first coating is hardened, using a UV source before the texturing is introduced.

13. The method according to claim 11, wherein the texturing is introduced by sanding.

14. The method according to claim 11, wherein the texturing is adjusted by changing a contact pressure, a relative speed between a device for introducing texturing and the workpiece, a direction of relative movement between a device for introducing texturing and the workpiece, or a change of the device for introducing texturing.

15. The method according to claims 11, wherein prior to application of the first coating, a decorative element is applied to the workpiece by an inkjet printing device.

16. The device according to claim 1, wherein the first coating or the second coating is a varnish.

17. The device according to claim 4, wherein the sanding belt is moved in a direction of relative movement between the workpiece and the sanding device.

18. The device according to claim 9, wherein the conveying device is configured as a belt conveyor, a conveyor belt or a conveyor chain.

19. The device according to claim 10, wherein the control device that is configured to control the device for introducing texturing in such a manner that the texturing is changed on the basis of a gloss scale, which is measured as a reflectometer value according to ISO 2813.

20. The method according to claim 11, wherein the first coating or the second coating is a varnish.
